(19) United States
(12) Patent Application Publication
(10) Pub. No.: US 2023/0266152 A1
(43) Pub. Date: Aug. 24, 2023

(54) Controlling a Sensor System

(71) Applicant: Siemens Aktiengesellschaft, München (DE)

(72) Inventor: Andreas Tobola, Erlangen (DE)

(73) Assignee: Siemens Aktiengesellschaft, München (DE)

(21) Appl. No.: 18/171,586

(22) Filed: Feb. 20, 2023

(30) Foreign Application Priority Data
Feb. 21, 2022 (EP) 22157742.2

(51) Int. Cl. G01D 18/00

(52) U.S. Cl. CPC G01D 18/00

(57) ABSTRACT

Various embodiments of the teachings herein include methods and/or systems for controlling a sensor system. For example, a method comprises: sensing a measured energy consumption profile of the sensor system using an energy measuring apparatus; comparing the measured energy consumption profile with one or more expected energy consumption profiles; selecting one expected energy consumption profile as closest to the measured energy consumption profile; defining at least one control command based on the closest energy consumption profile; and controlling the sensor system by executing the at least one control command.

### CROSS-REFERENCE TO RELATED APPLICATIONS

This application claims priority to EP Application No. 22157742.2 filed Feb. 21, 2022, the contents of which are hereby incorporated by reference in their entirety.

### TECHNICAL FIELD

The present disclosure relates to sensors. Various embodiments of the teachings herein include method and/or systems for controlling a sensor system.

### BACKGROUND

The main task of a sensor system is to read the sensors integrated therein and to at least preprocess the values that have been read, that is to say the sensor data, and to transmit them to a superordinate unit, in particular an edge device or a cloud. There, the data are evaluated by one or more sensor systems, in particular in order to detect damage early, with the result that a component can be proactively replaced in order to avoid more costly damage or a standstill of a production plant. If such a sensor system is supplied with energy using a battery or by means of energy harvesting, special attention is paid to a low energy consumption as early as during design through to the final test of the sensor system. The design measures relate to both the hardware and the software of the sensor system.

An undesirably higher energy consumption can result from external disruptions during operation of such an energy-saving sensor system. This is the case, in particular, in systems which are designed to be scalable, that is to say adapt their energy consumption to the conditions. A disruption, an unwanted modification, an incorrect configuration or the unauthorized entry to the system can considerably influence the energy consumption. However, this effect is detected too late or not in sufficient time.

### SUMMARY

The teachings of the present disclosure describe sensor systems which make it possible to avoid undesirably higher energy consumptions. For example, some embodiments include a method for controlling a sensor system (1), including: sensing (S1) a measured energy consumption profile of the sensor system (1) by means of an energy measuring apparatus, using (S2) expected energy consumption profiles, comparing (S3) the measured energy consumption profile with the expected energy consumption profiles, identifying (S4) a closest energy consumption profile from the expected energy consumption profiles, defining (S5) at least one control command on the basis of the closest energy consumption profile, and controlling (S6) the sensor system (1) by executing the at least one control command.

In some embodiments, the elements are carried out continuously or repeatedly, in particular at equal intervals of time, during use of the sensor system (1).

In some embodiments, a state of the sensor system (1) is assigned to each expected energy consumption profile, and the at least one control command, which is defined on the basis of the closest energy consumption profile, is matched to the state of the sensor system (1).

In some embodiments, the state of the sensor system (1) comprises: a configuration of the sensor system (1), and/or an influence caused by environmental conditions, and/or a modification of the sensor system (1), and/or a hardware defect, and/or a malfunction, and/or unauthorized intervention.

In some embodiments, the expected energy consumption profiles are modeled by a sensor system model (2).

In some embodiments, the sensor system model (2) is implemented: in a cloud environment, or on an edge device, or on the sensor system (1).

In some embodiments, the expected energy consumption profiles are assigned an uncertainty value and/or a tolerance which are taken into account when identifying the closest energy consumption profile.

In some embodiments, an associated deviation is determined with the identification of a closest energy consumption profile.

In some embodiments, the at least one control command comprises: energy control, and/or energy optimization, and/or a reduction in an amount of energy that is fed in, and/or regulation of an energy state of the sensor system, and/or reading a warning signal, and/or transmitting an error message, and/or transmitting a warning message, and/or activating a further sensor system (1), and/or switching off the sensor system (1).

As another example, some embodiments include a system comprising means for carrying out one or more of the methods as described herein.

In some embodiments, the system includes: an energy measuring apparatus designed to sense a measured energy consumption profile of a sensor system (1), a comparison unit designed to compare the measured energy consumption profile with expected energy consumption profiles, an identification unit designed to identify a closest energy consumption profile from the expected energy consumption profiles, a definition unit designed to define the at least one control command on the basis of the closest energy consumption profile, and a control unit designed to control the sensor system (1) by executing the at least one control command.

In some embodiments, the definition unit is in the form of an energy management unit which is designed to optimize energy consumed by the sensor system.

### BRIEF DESCRIPTION OF THE DRAWINGS

The special features and advantages of the teachings herein become clear from the following explanations of a plurality of exemplary embodiments on the basis of the schematic drawings. In the figures:

FIG. 1 shows a flowchart of the method incorporating teachings of the present disclosure; and

FIG. 2 shows a schematic illustration of a sensor system and a sensor system model incorporating teachings of the present disclosure.

### DETAILED DESCRIPTION

The teachings of the present disclosure include methods for controlling a sensor system, including:
sensing a measured energy consumption profile of the sensor system by means of an energy measuring apparatus,
using expected energy consumption profiles,
comparing the measured energy consumption profile with the expected energy consumption profiles,
identifying a closest energy consumption profile from the expected energy consumption profiles,
defining at least one control command on the basis of the closest energy consumption profile, and
controlling the sensor system by executing the at least one control command.

Deviations from a target state, which represents an expected energy consumption profile, can be detected in good time and measures can be taken against them.

In some embodiments, the energy measuring apparatus is a hardware and software expansion of the sensor system.

In some embodiments, the method includes determining the current energy requirement profile by measuring an energy consumption profile, which can also be referred to as an energy profile measurement. The measured energy profile is then compared with expected energy consumption profiles. The expected energy consumption profiles can be determined by means of a model, in particular. If the measured energy consumption profile corresponds to an expected energy consumption profile, in particular within the scope of a definable tolerance, no further action is required. The expected energy consumption profile can also be referred to as an energy consumption profile of a normal state.

In contrast, if the current energy profile does not correspond to the expected energy consumption profile, this is an indication of at least one error source. The respective closest energy consumption profile can provide information about the error source. This results in the advantage that various error states are also detected in addition to the expected normal state.

Error sources which can be detected, in particular, are:
safety-critical manipulation of the hardware or software of the sensor system,
unauthorized entry to the system,
unwanted modification,
incorrect configuration of the sensor system,
deviations of the expected firmware version,
partial defect of the hardware, in particular overheating and/or excessive vibration,
incorrect installation,
operation outside the intended purpose, and/or
external interfering influences.

The idea of the invention is explained below using two embodiments:
Scenario A: Normal state
Scenario B: Sensor hardware defect

### Scenario A

The energy consumption model here represents the normal state. In the normal state, the real sensor system operates according to a defined pattern. The sensor system is initially in the (P1) sleep mode, (P2) wakes up in the next step, (P3) then carries out a measurement, (P4) transmits the result of the measurement wirelessly, and (P5) finally enters the sleep state again. A specific power consumption is expected in each phase P1 to P5. This results in an energy profile, a progression of the power consumption of the sensor system over time. This energy profile is captured by the energy measuring apparatus. There follows a comparison between the energy consumption model and the energy measuring apparatus. If the energy profile corresponds to that of the energy consumption model in the “normal state” scenario, the desired normal state can be assumed.

### Scenario B

In this scenario, a measuring cycle like in scenario A is likewise expected, but it is assumed that a sensor causes a higher power consumption as a result of a hardware defect. The higher power consumption is shown by an increase in the energy consumption in certain phases. For example, in a sleep phase (P1), the sensor electronics are disconnected from the energy supply. In contrast, in the wake-up phase (P2), the microcontroller is in the sleep mode, but the sensor electronics are activated. In this case, the energy consumption model determines that the higher energy requirement in phase 2 can be attributed to a sensor defect because the “sensor defect” scenario corresponds most closely to this energy profile.

The first step of the method “sensing a measured energy consumption profile of the sensor system by means of an energy measuring apparatus” can also be referred to as “capturing an energy consumption profile as a progression of a power consumption of the sensor system over time”.

In some embodiments, the elements of the method are carried out continuously, permanently or repeatedly, in particular at equal intervals of time, during use of the sensor system. “Continuously” means that the steps are repeated continuously during use of the sensor system. “Repeatedly” means that the steps are carried out again multiple times in succession.

This means that the measured energy consumption profile of the sensor system is repeatedly sensed by means of the energy measuring apparatus. The repeatedly measured energy consumption profiles are continuously compared with the expected energy consumption profiles. This ensures, at any time, that a closest energy consumption profile can be identified from the expected energy consumption profiles and, in the event of a deviation, at least one control command can be defined on the basis of the closest energy consumption profile, which control command is used to control the sensor system. The best configuration in terms of energy (how often asleep, how often awake) for solving a problem with a defined quality is repeatedly determined and implemented.

In some embodiments, a state of the sensor system and/or an extent of the state is/are assigned to each expected energy consumption profile. In particular, the at least one control command, which is defined on the basis of the closest energy consumption profile, is also matched to the state of the sensor system. This has the advantage that the state of the sensor system can be inferred using the closest energy consumption profile.

In some embodiments, the state of the sensor system comprises:
a configuration of the sensor system, and/or
an influence caused by environmental conditions, and/or
a modification of the sensor system, and/or
a hardware defect, and/or
a malfunction, and/or
unauthorized intervention.

Different states of the sensor system can therefore be detected using the closest energy consumption profile and measures or control commands can be initiated if necessary.

In some embodiments, the expected energy consumption profiles are modeled by a sensor system model. In this case, the sensor system model acts as a virtual image of the real sensor system. The sensor system model for the present application can also be referred to as an energy consumption model. The sensor system model is a model for a particular sensor system that predicts the energy consumption on the basis of the environmental conditions and the sensor system configuration.

The sensor system model forms a digital twin (DT) by continuously communicating with the sensor system. The sensor system model is used to determine the expected energy consumption profiles and to use them to regulate the best energy state for the sensor system.

On the basis of the environmental conditions and the sensor system configuration, the digital twin indicates an estimate for the target energy consumption with a known uncertainty in order to then, in the event of a metrologically significant deviation, to be able to continuously determine this deviation in good time.

A disruption, an unwanted modification, an incorrect configuration or the unauthorized entry to the system can therefore be detected in good time in order to avoid considerably higher consequential damage such as, in particular, premature draining of the batteries and therefore failure of the sensor systems, and further penetration of malware into a plant.

In some embodiments, the sensor system model is implemented:
in a cloud environment, or
on an edge device, or
on the sensor system.

The implementation of the sensor system model on the sensor system has the advantage, in particular, that a possible deviation from a target state can be determined by the sensor system itself and can be provided as a quality parameter of the sensor system. This has the advantage that the sensor system has “self-awareness” and can itself make a statement on its measurement quality, also called “quality of sensing”.

In some embodiments, the expected energy consumption profiles are assigned an uncertainty value and/or a tolerance which are taken into account when identifying the closest energy consumption profile. This has the advantage that it is thereby possible to indirectly control when control commands are executed.

In some embodiments, an associated deviation is determined with the identification of a closest energy consumption profile. This likewise has the advantage that it is thereby possible to indirectly control when control commands are executed.

In some embodiments, the at least one control command comprises:
energy control, and/or
energy optimization, and/or
a reduction in an amount of energy that is fed in, and/or
regulation of an energy state of the sensor system, and/or
reading a warning signal, and/or
transmitting an error message, and/or
transmitting a warning message, and/or
activating a further sensor system, and/or
switching off the sensor system.

Some embodiments include a system comprising means for carrying out one or more of the methods described herein. For example, some systems include:
an energy measuring apparatus designed to sense a measured energy consumption profile of a sensor system,
a comparison unit designed to compare the measured energy consumption profile with expected energy consumption profiles,
an identification unit designed to identify a closest energy consumption profile from the expected energy consumption profiles,
a definition unit designed to define the at least one control command on the basis of the closest energy consumption profile, and
a control unit designed to control the sensor system by executing the at least one control command.

In some embodiments, the definition unit is in the form of an energy management unit in order to optimize energy consumed by the sensor system. This provides for a sensor system model to be continuously supplied with data, wherein the sensor system model determines the best configuration in terms of energy for the sensor system, in particular with regard to sleep and wake-up cycles, for solving a problem with a defined quality and communicates this configuration to the sensor system.

The desired quality may be predefined for various situations, is requested by the user or is defined by a policy. It is assumed that there is a solution which is implemented. This would result in a certain energy consumption. This expansion of the invention involves, in particular, regulating the best energy state for the sensor system using a digital twin, provided there are a plurality of solutions.

The teachings of the present disclosure and the embodiments thereof may provide the following advantages:
1. Continuously determining deviations during operation of a sensor system;
2. Continuously determining the best possible energy state for the sensor system; and
3. Continuously determining a quality measure (“quality of sensing”) for the sensor system in terms of the energy consumption, assuming that an operational disruption may also affect the accuracy of the measurement variables determined by the sensor system.

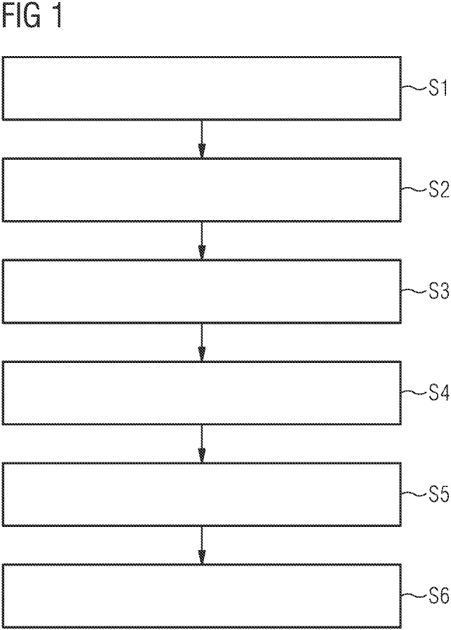

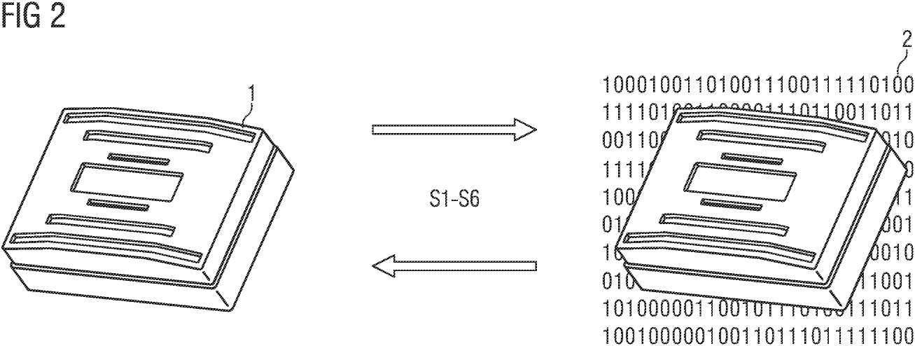

FIG. 1 shows a flowchart of an example method incorporating teachings of the present dislcosure. The method comprises the following steps:
Step S1: sensing a measured energy consumption profile of the sensor system 1 (illustrated in FIG. 2) by means of an energy measuring apparatus,
Step S2: using expected energy consumption profiles,
Step S3: comparing the measured energy consumption profile with the expected energy consumption profiles,
Step S4: identifying a closest energy consumption profile from the expected energy consumption profiles,
Step S5: defining at least one control command on the basis of the closest energy consumption profile, and
Step S6: controlling the sensor system 1 by executing the at least one control command.

FIG. 2 shows a schematic illustration of an example sensor system 1 and an example sensor system model 2 incorporating teachings of the present disclosure. By definition, a digital twin consists of three essential parts: an asset in the real world, the sensor system 1, an asset in the virtual world, the sensor system model 2, and permanent communication between the sensor system 1 and the sensor system model 2.

In some embodiments, the expected energy consumption profiles are modeled by the sensor system model 2. In this case, the sensor system model 2 acts as a virtual image of the real sensor system 1. The sensor system model 2 for the present application may also be referred to as an energy consumption model 2. The sensor system model 2 is a model 2 for a particular sensor system 1 that provides a prediction or expectation of the energy consumption on the basis of the environmental conditions and the configuration of the sensor system.

Although the teachings herein have been illustrated and described more specifically in detail by means of the exemplary embodiments, the scope of the disclosure is not restricted by the disclosed examples and other variations may be derived therefrom by a person skilled in the art without departing from the scope of protection.

1. A method for controlling a sensor system, the method comprising:
sensing a measured energy consumption profile of the sensor system using an energy measuring apparatus;
comparing the measured energy consumption profile with one or more expected energy consumption profiles;
selecting one expected energy consumption profile as closest to the measured energy consumption profile;
defining at least one control command based on the closest energy consumption profile; and
controlling the sensor system by executing the at least one control command.

2. The method as claimed in claim 1, further comprising repeating the elements repeatedly during use of the sensor system.

3. The method as claimed in claim 1,
wherein a state of the sensor system is assigned to each expected energy consumption profile; and
wherein the at least one control command matches the state of the sensor system.

4. The method as claimed in claim 3, wherein the state of the sensor system comprises a state selected from the group consisting of:
a configuration of the sensor system;
an influence caused by environmental conditions;
a modification of the sensor system;
a hardware defect;
a malfunction; and
an unauthorized intervention.

5. The method as claimed in claim 1, wherein the expected energy consumption profiles are produced by a sensor system model.

6. The method as claimed in claim 5, wherein the sensor system model is implemented: in a cloud environment, or on an edge device, or on the sensor system.

7. The method as claimed in claim 1, wherein the expected energy consumption profiles are assigned an uncertainty value and/or a tolerance used when identifying the closest energy consumption profile.

8. The method as claimed in claim 1, wherein an associated deviation is determined with the identification of a closest energy consumption profile.

9. The method as claimed in claim 1, wherein the at least one control command comprises at least one command selected from the group consisting of: energy control, energy optimization, a reduction in an amount of energy that is fed in, regulation of an energy state of the sensor system, reading a warning signal, transmitting an error message, transmitting a warning message, activating a further sensor system, and switching off the sensor system.

10. A system comprising:
an energy measuring apparatus sensing a measured energy consumption profile of a sensor system;
a comparison unit comparing the measured energy consumption profile with expected energy consumption profiles;
an identification unit identifying one of the expected energy consumption profiles as closest energy consumption profile to the measured energy consumption profile;
a definition unit defining at least one control command based on the closest energy consumption profile; and
a control unit controlling the sensor system by executing the at least one control command.

11. The system as claimed in claim 10, wherein the definition unit comprises an energy management unit designed to optimize energy consumed by the sensor system.
